(19) United States
(12) Patent Application Publication
(10) Pub. No.: US 2017/0291967 A1
(43) Pub. Date: Oct. 12, 2017

(54) POLYHYDROXYALKANOATE FLAME RETARDANTS

(71) Applicant: International Business Machines Corporation, Armonk, NY (US)

(72) Inventors: Scott B. KING, Rochester, MN (US); Brandon M. Kobilka, Tucson, AZ (US); Joseph Kuczynski, North Port, FL (US); Jason T. Wertz, Pleasant Valley, NY (US)

(21) Appl. No.: 15/094,762

(22) Filed: Apr. 8, 2016

(51) Int. Cl. C08F 8/40

(52) U.S. Cl. CPC C08F 8/40

(57) ABSTRACT

Embodiments of the disclosure generally provide compositions and methods involving the reaction extrusion of flame retardant polyhydroxyalkanoates with renewable resource content.

### FIELD

The present disclosure generally relates to polyhydroxyalkanoate flame retardant polymers produced by reactive extrusion processing.

### BACKGROUND

Many polymers and thermoplastics, which may be formed or molded into objects for use in a number of fields including construction, automotive, and aerospace, are combustible when heated to a high enough temperature in the presence of oxygen. The pyrolysis of the polymer structure may yield toxic chemical species such as volatile hydrocarbons, hydrogen, and hydroxyl free radicals. The pyrolysis products formed during decomposition are high in energy and may further react with oxygen, releasing heat and causing fire to spread. To prevent or retard burning, flame retardant materials may be added to polymers to increase resistance to ignition, reduce flame spread, and suppress smoke formation.

The trend in recent years, driven principally by environmental and safety concerns, has been towards an increase in use of halogen-free flame retardants, such as phosphorus-based inorganic and organic flame retardants. These include organic phosphate esters, phosphates, and inorganic phosphorus salts. They act in various ways to extinguish a flame. For example, some terminate active hydrogen and hydroxyl radicals in the vapor phase, and some yield phosphoric acids in the presence of fire. The acids alter how a polymer degrades when exposed to heat and promote char formation which limits further polymer decomposition. Although phosphorus-based flame retardants are effective in polymers typically as an additive, they may decompose at polymer melt extrusion temperatures. Therefore, it would be an advantage to have a melt-processable polymer that contains flame retardant phosphorus groups, such as covalently bonded phosphorus groups, that do not decompose at temperatures found in typical molding and/or extrusion processes. It would be a further advantage, from the environmental standpoint, to have a flame retardant phosphorous-containing polymer that is derived from renewable resources, so that both costs and environmental impacts may be reduced.

### SUMMARY

This disclosure describes a method of producing a flame retardant material that involves forming a molten polyhydroxyalkanoate polymer in a polymer extrusion apparatus in an apparatus zone at a first temperature and a first time; reacting the polyhydroxyalkanoate polymer with at least one additive in an apparatus zone at a second temperature and a second time; and isolating the extrudate. The method may be a reactive extrusion, wherein the polyhydroxyalkanoate is a reaction product obtained from the reactive extrusion method, and the additive is flame retardant and contains phosphorous. In some embodiments, the additive forms a reaction product with the polyhydroxyalkanoate polymer that has at least one phosphorous group, wherein the group is an organophosphorous group. The organophosphorous group may have at least one alkyl group, and/or at least one aryl or phenyl group, and the phosphorous group is selected from: phosphinates, phosphonates, and phosphates.

This disclosure further describes a flame retardant object, containing a polyhydroxyalkanoate polymer that has phosphorous groups that are covalently bonded phosphorous groups. The phosphorous groups are organophosphorous groups, and are selected from: phosphinates, phosphonates, and phosphates. The phosphorous groups are covalently bonded to the polymer backbone or main chain, and/or are pendant groups. The flame retardant object as described herein contains a polyhydroxyalkanoate polymer that is the reaction product of at least one unsaturated fatty acid with a bacterium, and the unsaturated fatty acid may contain a terminal double bond. The fatty acid may also be a naturally occurring compound.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of the disclosure and are therefore not to be considered limiting of its scope, for the disclosure may admit to other equally effective embodiments.

FIG. 1 is a table of polymer structures according to some embodiments of this disclosure.

FIGS. 2A-2C show a synthetic scheme according to an embodiment of this disclosure.

FIGS. 3A and 3B show a synthetic scheme according to an embodiment of this disclosure.

FIGS. 4A-4C show a synthetic scheme according to an embodiment of this disclosure.

FIG. 5 illustrates synthetic schemes according to some embodiments of this disclosure.

### DETAILED DESCRIPTION

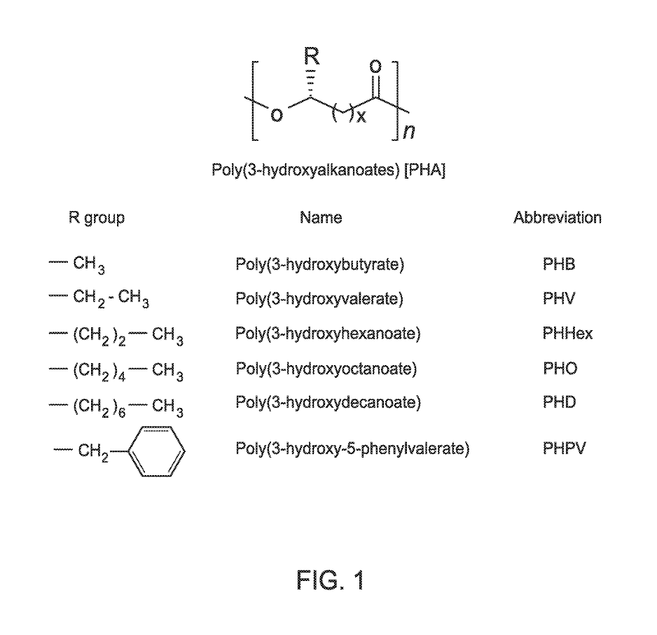

The present disclosure provides flame retardant compositions and methods involving phosphorous-containing inorganic-organic hybrid materials that are based on polyhydroxyalkanoate (PHA) polymers. Polyhydroxyalkanoates (PHAs) are a family of naturally-occurring biopolyesters that may be synthesized by various microorganisms, such as by bacterial fermentation of sugar or lipids. Polyhydroxyalkanoates are attractive industrially because they are biodegradable, biocompatible, feature a large chemical diversity, and may be produced from renewable resources. As represented by FIG. 1, a PHA repeat unit has hydroxy acid monomer units with —CH₂— groups (x=1, 2) and a side chain R group, which may also be a chiral group. A PHA may also be known as a poly(3-hydroxyalkanoate) because of the position of the monomer hydroxyl group with respect to the carbonyl carbon (C1). Poly-3-hydroxybutyrate (PHB) is one type of polyhydroxyalkanoate, but other polymers of this class are produced by a variety of organisms and include poly-4-hydroxybutyrate (P4HB), polyhydroxyvalerate (PHV), polyhydroxyhexanoate (PHH), polyhydroxyoctanoate (PHO) and their copolymers.

This disclosure describes materials and methods related to the synthesis, reactive extrusion, and modification of new flame retardant bio-based PHAs and related polyesters. The new PHAs have phosphorous-containing groups, such as an organic ester of phosphorus, that may include, but are not restricted to: phosphinates (OP(OR)R₂), phosphonates (OP(OR)₂R), and phosphates (OP(OR)₃), where R may be an organic group or may be a halogen, and the R groups may vary from molecule to molecule, or within the same molecule. Advantageously, the production of the new flame retardant PHAs may be achieved by conducting synthetic reactions within a polymer extruder, such as extruders produced by Clextral of Firminy, France. Such a technique may be known as a reactive extrusion technique, and may utilize an extruder, such as co-rotating intermeshing twin screw extruder, as a continuous chemical reactor, wherein a preformed PHA may be introduced, or produced in situ (in the extruder), and wherein the PHA polymer may subsequently undergo one or more chemical reaction(s) with at least one additive, or itself, during a polymer extrusion process. For example, in some embodiments, a reactive extrusion process may involve the sequential addition of reactive and/or inert (non-reactive) additives such as small molecules, oligomers, polymers, free radical initiators, crosslinking agents, anti-oxidants, inert gases, coupling agents, and mineral fillers. Advantageously, reactive extrusion involving PHAs may occur in parallel with screw extruder conventional functions such as solids conveying, melting, mixing, and melt pumping. The extruded flame retardant PHA material (extrudate) thus produced may then be processed into an object by any number of techniques including injection molding, blow molding, transfer molding, compression molding, rotational molding, stamping, machining, computer numerical control (CNC) machining, water jet cutting, laser cutting, and die cutting.

In embodiments of this disclosure a PHA produced by reactive extrusion may have heteroatoms or other functional groups that may undergo further reaction to create a flame retardant polymer. There are no restrictions on the types of reactions that a PHA may undergo in a reactive extrusion process, and include, but are not restricted to: synthesis, decomposition, single replacement and double replacement, oxidation/reduction, acid/base, nucleophilic, electrophilic and radical substitutions, addition/elimination reactions, grafting and chain extension; and polymerization reactions such as condensation, step-growth, chain-growth and addition, acrylic free radical, cationic epoxy, Michael addition, ring-opening, and ring-forming or Diels-Alder polymerization types.

A PHA material in a twin-screw extruder may be contacted with an additive that may react with portions of a PHA material's macromolecular structure such as PHA chain ends, R groups and/or pendant groups, and/or the polymer backbone or main chain; and thus create a PHA with new groups that may be aliphatic, aromatic, mixtures thereof, and may have groups and/or structures that are linear, branched, and/or dendritic. In some embodiments, the PHA may have reactive functional groups that may be at least monofunctional, and those multifunctional groups may serve as foci for crosslinking, and are therefore useful for tuning the materials modulus and hardness. In further embodiments of this disclosure, groups bonded to the polymer main backbone may be an aliphatic group, an aromatic group or combinations thereof, and may also contain sites of unsaturation such as double or triple bonds, or other functional groups that may undergo any number of reactions to produce new groups or polymeric segments. For example, in some embodiments, oligomeric and polymeric groups or segments may be added to or grafted to a PHA by a reactive extrusion process, and include, but are not restricted to groups or materials selected from: polyamides, polycarbonates, polyesters, polyether ketones, polyethers, polyoxymethylenes, polyether sulfone, polyetherimides, polyimides, polyolefins, polysiloxanes, polysulfones, polyphenylenes, polyphenylene sulfides, polyurethanes, polystyrene, polyacrylonitriles, polyacrylates, polymethylmethacrylates, polyurethane acrylates, polyester acrylates, polyether acrylates, epoxy acrylates, polycarbonates, polyesters, melamines, polysulfones, polyvinyl materials, acrylonitrile butadiene styrene (ABS), copolymers derived from styrene, copolymers derived from butadiene, halogenated polymers, block copolymers and copolymers thereof. Grafting of such groups and or polymers, may be achieved by a number of methods including thermally induced free radical reactions or nucleophilic addition. Examples of suitable free radical initiators that may be useful include azo compounds, and the inorganic and organic peroxides such as tert-butyl perbenzoate, dicumyl peroxide, benzoyl peroxide, and di-tert-butyl peroxide. In further embodiments involving free radical reactions, unsaturated groups may undergo free radical polymerization when exposed to radiation, such as UV radiation, in the presence of a curing agent, such as a free radical photoinitiator, such as an Irgacure® product. These materials and chemical reagents are available from BASF of Ludwigshafen, Germany, Sigma-Aldrich of St. Louis, Mo., USA and Huntsman Advanced Materials, The Woodlands, Tex., USA.

In further embodiments, the R group or other pendant groups (e.g. FIG. 1) may contain functional groups such as amides, epoxies, ethers, esters, ketones, aldehydes, sulfones, sulfoxides, and the esters of heteroatoms such as phosphorous. In addition to the R groups, a flame retardant PHA may contain the aforementioned group in the polymer chain or backbone. In one embodiment, a PHA chain segment may be linked or copolymerized with flame retardant groups, such as phosphorus-containing groups which may include organic esters of phosphorous, including the phosphinates (OP(OR)R₂), phosphonates (OP(OR)₂R), and phosphates (OP(OR)₃), where R may be an organic group which vary within a molecule or between different or the same molecules. For the purposes of this disclosure, we do not restrict or limit the chemical make-up or identity of the groups that may be added to or reacted with a PHA in a reactive extrusion process.

In some embodiments inert and/or reactive additives or process aids may be added to a reactive extrusion process involving PHA, and may include lubricants, nucleating agents, extension oils, organic and inorganic pigments, anti-oxidants and UV-protectors, inert gases, heat stabilizers, plasticizers, fillers, and coupling agents. For example, plasticizers such as dioctyl phthalate, dioctyl adipate, and triacetyl glycerol may be added to an extrusion process at a concentration between about 5 and about 30% wt. based on polymer. The plasticizers may be used to modify the thermal and mechanical properties of a PHA such as glass transition temperature (Tg), melting temperature (Tm), degree of crystallinity, and mechanical properties such as modulus. In further embodiments, carbon and mineral fillers may be co-mixed with PHAs as part of a reactive extrusion process, and may be selected from the group including, but not restricted to: carbon black, graphite, carbon fiber, carbonate minerals, magnesium carbonate, hydromagnesite, huntite, hydroxide minerals, aluminum trihydroxide, magnesium hydroxide, brucite, boehmite, bauxite, borates, flame retardant synergists, clays, organoclays, and oxides of antimony. The filler may enable synergistic interactions that yield unexpected flame retardancy benefits, and may become covalently bonded or chemoabsorbed to the PHA. In other embodiments, coupling agents may be used in a PHA reactive extrusion process as plasticizers, reactive polymer modifying agents, and mineral filler surface modification agents. The coupling agent may modify the surface properties of the polymers so as to enhance mixing, lower friction, and/or increase chemical compatibility. Coupling agents may be selected from the group including but not restricted to: silanes, titanates, zirconates, aluminates, carboxylic acids, inorganic and organic esters, and phosphates.

In one embodiment, a new PHA may be produced by an enzymatic reactive extrusion process within a first extruder zone before further reaction or structural modification in a next zone. For example, the starting materials for PHA synthesis (e.g. bacterium, sugar, lipid) may be introduced in a first extruder zone by injection to create a PHA in situ, which after formation, may then travel down the length of a twin screw extruder in a molten state to another zone that is fitted with more additive injectors and ports. During a residence time, or the time during which a mass and/or a volume of the molten PHA traverses the extruder, such as between about 1 minute and about 20 minutes, modification of the molten PHA may be achieved by the addition of reactive additives to produce new chemical groups that are covalently bonded to the PHA, such as grafted side-chains containing sites of unsaturation, copolymerized groups from reactive PHA chain ends, and/or other functional groups for further reactive polymerization. For example, in one embodiment, a PHA may be contacted with and reacted with a small molecule flame retardant additive, such as an additive that has a phosphorous ester group such as a phosphinate, phosphonate, and/or phosphate group; and thus produce a new PHA that contains covalently bonded flame retardant phosphorous groups. The PHA bound phosphorous groups may reside in any number of structural positions, such as in or as part of the PHA backbone or main chain and/or as a pendant group or side-chain that may hang of the PHA backbone or main chain. In further embodiments, the flame retardant groups may be small molecule fragments, oligomers and/or polymers that are grafted onto the PHA backbone or main chain to create a new flame retardant PHA. For example, a pre-formed PHA may be first melted in a zone of an extruder, and then subsequently contacted with and/or reacted with an additive that may covalently bind new groups, such as flame retardant groups to the polymer.

In any zone or stage of a reactive extrusion process, synthesis and/or modification of PHAs may be achieved. In one embodiment, functional groups or side chain groups of a PHA may be grafted to or copolymerized with other functional monomers, oligomers, and/or polymers, including, but not restricted to: alpha-beta unsaturated esters, acrylates, methacrylates, alkyl methacrylates, cyanoacrylates, acrylonitrile, acrylamides, maleimides, vinyl sulfones, vinyl sulfoxides, vinyl sulfones, vinyl ketones, nitro ethylenes, vinyl phosphonates, acrylonitrile, vinyl pyridines, azo compounds, beta-keto acetylenes, acetylene esters, polylactic acid, polyurethanes, polycarbonates, acrylonitrile butadiene styrene (ABS), polyesters, polyethers, and copolymers thereof; and/or any blend of polymers that are capable of bonding with the functional group or side-chain group.

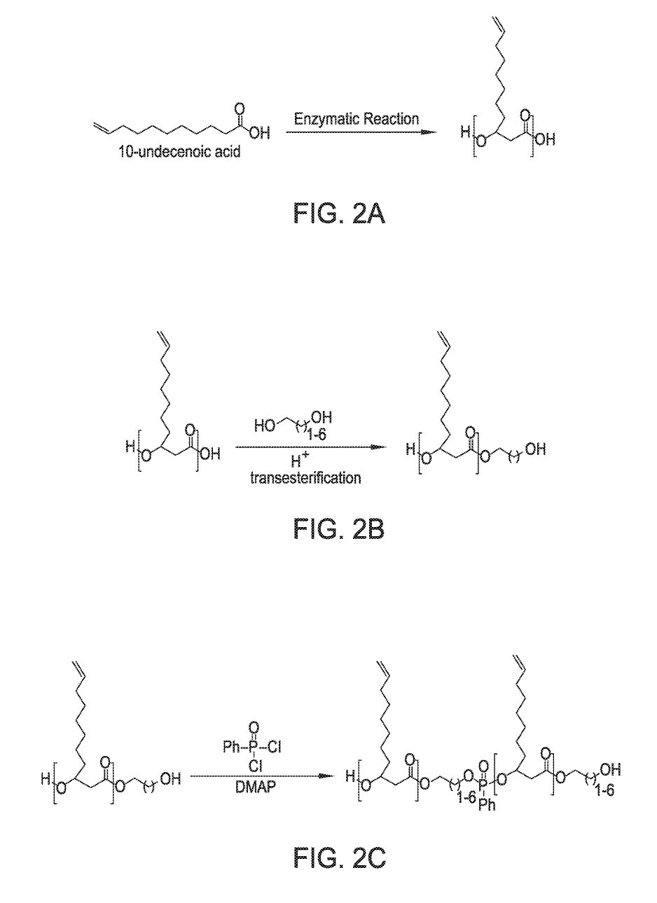

FIGS. 2A-2C illustrate a synthesis of a PHA-phosphonate material from 10-undecenoic acid, according to an embodiment of this disclosure. We note that 10-undecenoic acid is a bio-based renewable material derived from the cracking of castor oil, and that any suitable fatty acid with a terminal double bond may be used, for example a naturally occurring fatty acid. In a first step, as shown in FIG. 2A, a PHA is produced by enzymatic reaction of 10-undecenoic acid with a suitable bacterium such as Pseudomonas oleovarans in a first zone of a reactive extruder. Alternately, the PHA may be produced in a prereactor and then fed into an extruder. The PHA product of the reaction in FIG. 2A may have a side chain, pendant group or R group in the 3 position (relative to the carbonyl carbon atom, which is the 1 position) that has a terminal double bond, which is available for reaction with other polymers by a free radical polymerization, oxidation or by other means. Next, as shown in FIG. 2B, the PHA polymer may reach a second zone or another zone in the extruder wherein the carboxylic acid end groups of the PHA are reacted with a linear or branched diol such as a glycol and/or a propylene glycol, to produce esterified PHA chain ends with terminal hydroxyl groups. In some embodiments, the glycols may be obtained from bio-based sources to keep the renewable content at a maximum. Importantly, the addition of the hydroxy-terminated chain ends by esterification enables the copolymerization of a flame retardant group, such as a phosphorus-containing group in step 3. As shown in FIG. 2C, a hydroxyl-terminated PHA is reacted with an additive that contains phosphorous, such as phenylphosphonic dichloride and a catalytic amount of dimethylaminopyridine (DMAP) to produce a new flame retardant poly(PHA-phosphonate) with R groups or side chains that have sites of unsaturation for further reaction. In one embodiment, a 1 molar equivalent of a PHA and a catalytic amount (approximately 5 mole %) of 4-(dimethylaminopyridine) (DMAP) may be added to a dry reaction vessel under an inert atmosphere and dissolved in a solvent such as diethyl ether, dichloromethane, chloroform, or THF. Phenylphosphonic dichloride may then be added slowly to the reaction mixture while stirring, to form the reaction product as shown in FIG. 2C. The reaction may be carried out at or above room temperature, under reflux conditions and with stirring, for example magnetic stirring or other motorized stirring, with proper venting of and/or capture of corrosive HCl by-product. Those skilled in the art may choose to isolate and purify the products using any number of techniques including solvent extraction and solvent washing techniques, chromatography, and/or distillation. The aforementioned additives or chemical reagents may be obtained from Sigma-Aldrich of St. Louis, Mo., USA.

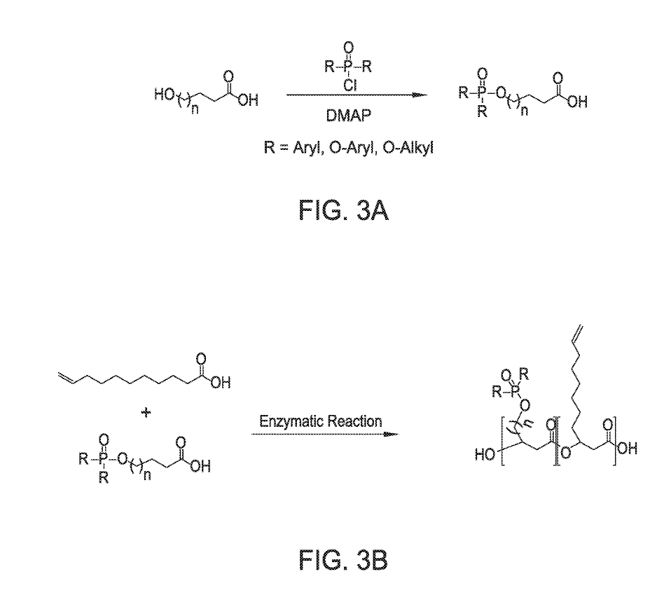

FIGS. 3A and 3B illustrate the formation of another type of a phosphorous containing flame retardant PHA, according to an embodiment of this disclosure. As shown in FIG. 3A, a hydroxy-terminated carboxylic acid is reacted with a phosphonic monochloride (R may be alkyl, aryl or other groups) to produce a phosphonate-terminated aliphatic acid. The experimental procedure may be similar to that described for FIG. 2C, and the moles of the reacting compounds may be adjusted to accommodate the phosphonic monochloride. As shown in FIG. 3B, a vinyl-terminated aliphatic acid may undergo a fermentation to yield a random copolymer that can be used as is, or may be functionalized further in a reactive extrusion process.

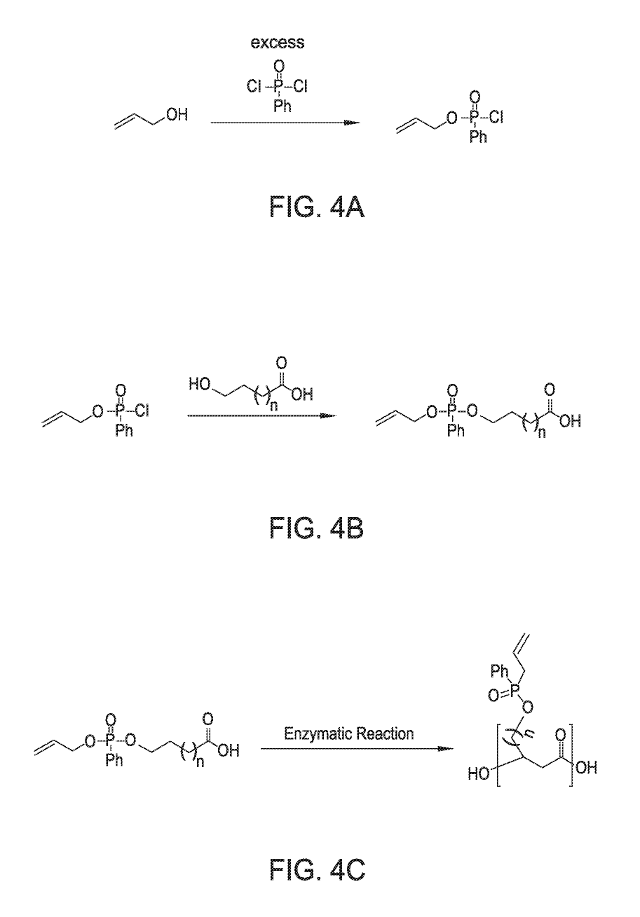

FIGS. 4A-4C illustrate another method that may be used to produce a PHA that has a flame retardant phosphorous group, according to an embodiment of this disclosure. As shown in FIG. 4A, an allyl alcohol is reacted with excess phenylphosphonic dichloride to produce a phosphorous allyl ester. As shown in FIG. 4B, the phosphorous allyl ester may be reacted with an alcohol-terminated carboxylic acid to obtain a carboxylic acid that is end terminated with a phosphorous allyl ester. The experimental procedure may be similar to that described for FIG. 2C, and the moles of the reacting compounds and other parameters may be adjusted by those skilled in the art to optimize product yield. As shown in FIG. 4C, an enzymatic reaction or fermentation may be performed to yield a flame retardant PHA containing phosphinate mono-ester groups which may be represented by the general formula (OP(OR)R₂), where R is an organic group.

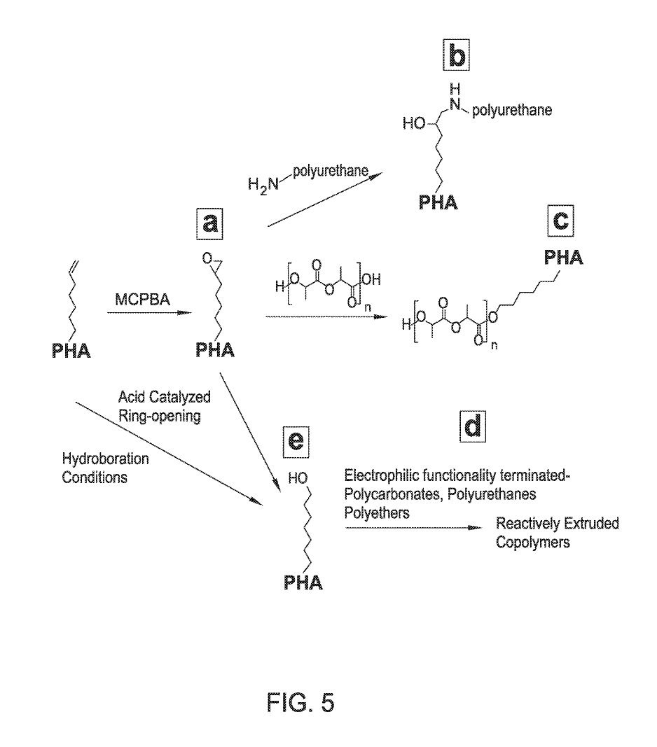

FIG. 5 illustrates some reactions that may be performed, and a variety of products that may be obtained under reactive extrusion conditions, according to embodiments of this disclosure. The products, denoted by the lower case letters “a-e” (letters in boxes) are shown in a clockwise direction in FIG. 5. Starting with the product designated by the letter “a”, a flame retardant PHA with an unsaturated group may be converted to the epoxide product “a” by reaction with meta-chloroperbenzoic acid (MCPBA). In one example, the double bond terminated PHA may be dissolved in an organic solvent such as diethyl ether, dichloromethane, chloroform, or THF, and the reaction may be carried out at or below room temperature. An organic peracid, such as MCPBA may be added slowly to the PHA solution with stirring, wherein the MCPBA is at least one mole equivalent with respect to PHA. To isolate, the crude reaction mixture may be poured into a PHA-polymer non-solvent which may include hexane, methanol, ethanol, and acetone, and the polymer may be purified by any combination of filtration, re-precipitation, Soxhlet extraction, or other techniques known to those skilled in the art. The crude organic mixture may also be rinsed with water, and the layers may be separated. The aqueous layer may be extracted with additional organic solvent (e.g., 3 times). The combined organic layers may be washed with aqueous sodium bicarbonate (e.g., 3 times), dried over MgSO₄, and filtered through a pad of silica gel. The solvents may be removed in vacuo, and further purification may be performed according to various techniques.

In another embodiment, as shown in FIG. 5, the “a” epoxy group may serve as a site for further reaction, such as reaction with an amine, such as an amine containing a polyurethane segment, to produce a product “b”. In one example, an epoxide-functionalized PHA and a polyurethane that may possess a terminal amine, amide, or urea and may be added to an extruder at an elevated temperature above the melting point of both polymers. A chain extender may also be added, such as a PHA monomer or oligomer. The polymeric mixture may then undergo high-shear mixing and the addition of a catalyst. The catalyst may be a Lewis acid, and may include dibutyltin dilaurate and/or stannous octonoate, or other suitable catalysts. The catalyst may also be a Lewis base and may include a tertiary amine such as diisopropylethylamine. The catalyst may also be an Arrhenius acid such as toluene sulfonic acid. The reactive mixture may then undergo a reacting phase, a de-volatilization phase, or a by-product removal phase. The compounds are processed in the extruder until the copolymerization reaction is complete and may be ejected via a die-mold port as determined by the user.

Alternatively, “a” may be reacted with a polyester segment to produce a copolymer containing two polyesters (e.g. a PHA segment and another polyester segment), as represented by “c”. In one example, epoxide-functionalized PHA and polylactic acid (PLA) may be added to a twin-screw extruder at an elevated temperature above the melting point of both polymers. A chain extender might also be added, such as a PLA monomer or oligomer. The polymeric mixture may then undergo high-shear mixing which may be followed by the addition of a catalyst. The catalyst may be a Lewis acid and may include dibutyltin dilaurate and/or stannous octonoate. The catalyst may also be a Lewis base and may include a tetrabutylammonium halide. The catalyst may also be an Arrhenius acid such as toluene sulfonic acid. The reactive mixture may then undergo a reacting phase, a de-volatilization phase, or a by-product removal phase. The compounds may be processed in the extruder until the copolymerization reaction is complete and are ejected via a die-mold port as determined by the user.

Reaction product “e”, a PHA with a terminal hydroxylated side chain or pendant group, may be produced from the acidic ring opening of “a” or by hydroboration of “a”, using methods known by those skilled in the art. The product “e” may be then reacted with electrophilic polymer groups to produce a “d” product or products in a reactive extrusion process. For example, a hydroxyl-functionalized PHA and a polyurethane may be added to a twin-screw extruder at an elevated temperature above the melting point of both polymers. A chain extender may be added, such as methylene diphenyl diisocyanate (MDI), toluene diisocyanate (TDI), isophorone diisocyanate (IPDI), hexamethylene diisocyanate (HDI), or pentamethylene diisocyanate (PDI). The polymeric mixture may undergo high-shear mixing which may be followed by the addition of a catalyst. The catalyst may be a Lewis acid and may include dibutyltin dilaurate and/or titanium isopropoxide. The catalyst may be an Arrhenius acid which may include toluene sulfonic acid. The reactive mixture may then undergo a reacting phase, a de-volatilization phase, or a by-product removal phase. The compounds are processed in the extruder until the copolymerization reaction is complete and are ejected via a die-mold port as determined by the user.

While the foregoing is directed to embodiments of the present disclosure, other and further embodiments of the disclosure may be devised without departing from the basic scope thereof, and the scope thereof is determined by the claims that follow.

1. A method of producing a flame retardant material, comprising:
forming a molten polyhydroxyalkanoate polymer in a polymer extrusion apparatus at a first temperature and a first time;
reacting the polyhydroxyalkanoate polymer with at least one additive at a second temperature and a second time; and
isolating the extrudate.

2. The method of claim 1, wherein the method is reactive extrusion.

3. The method of claim 2, wherein the polyhydroxyalkanoate is a reaction product of a method that includes reactive extrusion.

4. The method of claim 1, wherein the additive is flame retardant.

5. The method of claim 4, wherein the additive comprises phosphorous.

6. The method of claim 1, wherein the additive forms a reaction product with the polyhydroxyalkanoate polymer that is flame retardant.

7. The method of claim 6, wherein the reaction product is a polyhydroxyalkanoate polymer comprising at least one phosphorous group.

8. The method of claim 7, wherein the group is an organophosphorous group.

9. The method of claim 8, wherein the organophosphorous group comprises at least one alkyl group.

10. The method of claim 8, wherein the organophosphorous group comprises at least one aryl or phenyl group.

11. The method of claim 8, wherein the phosphorous group is selected from: phosphinates, phosphonates, and phosphates.

12. An flame retardant object, comprising:
a polyhydroxyalkanoate polymer that comprises phosphorous groups.

13. The flame retardant object of claim 12, wherein the polyhydroxyalkanoate polymer comprises covalently bonded phosphorous groups.

14. The flame retardant object of claim 13, wherein the phosphorous groups comprise organophosphorous groups.

15. The flame retardant object of claim 14, wherein the organophosphorous groups are selected from: phosphinates, phosphonates, and phosphates.

16. The flame retardant object of claim 13, wherein the phosphorous groups are covalently bonded to the polymer backbone or main chain.

17. The flame retardant object of claim 16, wherein the phosphorus groups are pendant to the polymer backbone or main chain.

18. The flame retardant object of claim 12, wherein the polyhydroxyalkanoate polymer is the reaction product of at least one unsaturated fatty acid with a bacterium.

19. The flame retardant article of claim 18, wherein the unsaturated fatty acid comprises a terminal double bond.

20. The flame retardant article of claim 19, wherein the unsaturated fatty acid is naturally occurring compound.
